(19) United States
(12) Patent Application Publication
(10) Pub. No.: US 2022/0013023 A1
(43) Pub. Date: Jan. 13, 2022

(54) MULTIPLE INSTANCE LEARNING FOR CONTENT FEEDBACK LOCALIZATION WITHOUT ANNOTATION

(71) Applicant: Pearson Education, Inc., Bloomington, MN (US)

(72) Inventors: Scott HELLMAN, BLOOMINGTON, MN (US); Peter W. FOLTZ, BLOOMINGTON, MN (US); Lee BECKER, BLOOMINGTON, MN (US); William R. MURRAY, BLOOMINGTON, MN (US)

(21) Appl. No.: 17/374,621

(22) Filed: Jul. 13, 2021

Related U.S. Application Data
(60) Provisional application No. 63/051,215, filed on Jul. 13, 2020.

(51) Int. Cl. G09B 5/02; G06Q 50/20; G06N 20/20

(52) U.S. Cl. CPC G09B 5/02; G06N 20/20; G06Q 50/20

(57) ABSTRACT

The disclosed embodiments include a method to predict annotation spans without requiring any labeled annotation data. The approach is to consider AES as a Multiple Instance Learning (MIL) task. The disclosed embodiments show that such models can both predict content scores and localize content by leveraging their sentence-level score predictions. This capability arises despite never having access to annotation training data. Implications are discussed for improving formative feedback and explainable AES models.

### CROSS-REFERENCE TO RELATED APPLICATION(S)

This application claims the benefit of priority from provisional application No. 63/051,215 filed on Jul. 13, 2020, and titled MULTIPLE INSTANCE LEARNING FOR CONTENT FEEDBACK LOCALIZATION WITHOUT ANNOTATION, the entire contents of which is incorporated herein by reference.

### STATEMENT OF FEDERALLY SPONSORED RESEARCH OR DEVELOPMENT

Not applicable

### FIELD OF THE DISCLOSURE

This disclosure relates to Automated Essay Scoring (AES), and automatically generating holistic scores with reliability comparable to human scoring, as well as providing formative feedback to learners, typically at the essay level.

### SUMMARY OF THE DISCLOSURE

The present invention provides systems and methods comprising one or more server hardware computing devices or client hardware computing devices, communicatively coupled to a network, and each comprising at least one processor executing specific computer-executable instructions within a memory that, when executed, cause the system to: predict annotation spans without requiring any labeled annotation data. The approach is to consider AES as a Multiple Instance Learning (MIL) task. The disclosed embodiments show that such models can both predict content scores and localize content by leveraging their sentence-level score predictions. This capability arises despite never having access to annotation training data. Implications are discussed for improving formative feedback and explainable AES models.

### BRIEF DESCRIPTION OF THE DRAWINGS

FIG. 1 is a system level block diagram for automatically generating holistic scores for automated essay scoring with reliability comparable to human scoring according to the present disclosure;

FIG. 2 is a system level block diagram for automatically generating holistic scores for automated essay scoring with reliability comparable to human scoring according to the present disclosure;

FIG. 3 is an example user interface for automatically generating holistic scores for automated essay scoring with reliability comparable to human scoring according to the present disclosure;

FIG. 4 is box plots of inter-annotator correlations of the sentence-level annotation labels for each topic and correlation between scores for all topic pairs according to the present disclosure; and

FIG. 5 is annotation prediction performance of the kNN-MIL models as k is varied, averaged across all prompts, concepts, and annotators according to the present disclosure.

### DETAILED DESCRIPTION

The following describes one or more example embodiments of the disclosed system for automatically generating holistic scores with reliability comparable to human scoring, as well as providing formative feedback to learners, typically at the essay level, as shown in the accompanying figures of the drawings described briefly above.

The present inventions will now be discussed in detail with regard to the attached drawing figures that There briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, the well-known machines, structures, and method steps have not been described in particular detail in order to avoid unnecessarily obscuring the present invention. Unless otherwise indicated, like parts and method steps are referred to with like reference numerals.

The assessment of writing is an integral component in the pedagogical use of constructed response items. Often, a student's response is scored according to a rubric that specifies the components of writing to be assessed, such as content, grammar, and organization, and establishes an ordinal scale to assign a score for each of those components. Furthermore, evidence exists that suggest learning improvements when instructors provide feedback to their students. The instructors' comments may take the form of holistic, document-level feedback, or more specific, targeted feedback that addresses an error or praises an insight at relevant locations in the paper.

Computers may be employed in essay scoring, as evidenced by the area of automated essay scoring (AES). However, many of these systems are limited to providing holistic scores. That is, they assign an ordinal value for every component in the rubric. Thus, although some AES systems can provide document-level feedback, this requires students to interpret which parts of their text the feedback refers to.

The collection of human-generated annotations is a major bottleneck to building writing feedback systems. Constructing a system that does not require this data allows the disclosed embodiments to move more quickly on giving direct feedback to students. This opens the pathway to improve automated formative feedback systems for student written answers that can explain to the student how to fix problems in their writing.

Formative feedback on student writing is most useful when it is localized to the particular location in the essay that it applies to. Conventional approaches to this localization task require examples of human-provided localized annotations, which is time-consuming and expensive to gather.

Formative feedback on student writing is most useful when it is localized to the particular location in the essay that it applies to. Conventional approaches to this localization task require examples of human-provided localized annotations, which is time-consuming and expensive to gather. The disclosed embodiment therefore includes systems and methods to predict annotation spans in student essays without requiring any labeled annotation training data. Specifically, the disclosed embodiments provide for Multiple Instance Learning (MIL) for content feedback localization without annotation, specifically utilizing Automated Essay Scoring (AES) as a MIL task. This approach may predict content scores and localize content by leveraging its sentence-level score predictions, despite never having access to localization training data. This represents a significant improvement over the current and prior states of the art, because MIL has never been and is not currently applied to the AES task, the current and prior state of the art includes no other attempts to approach content localization without access to annotation data. The disclosed system may therefore perform both annotation localization and essay scoring and may further be utilized for explainable automated essay scoring.

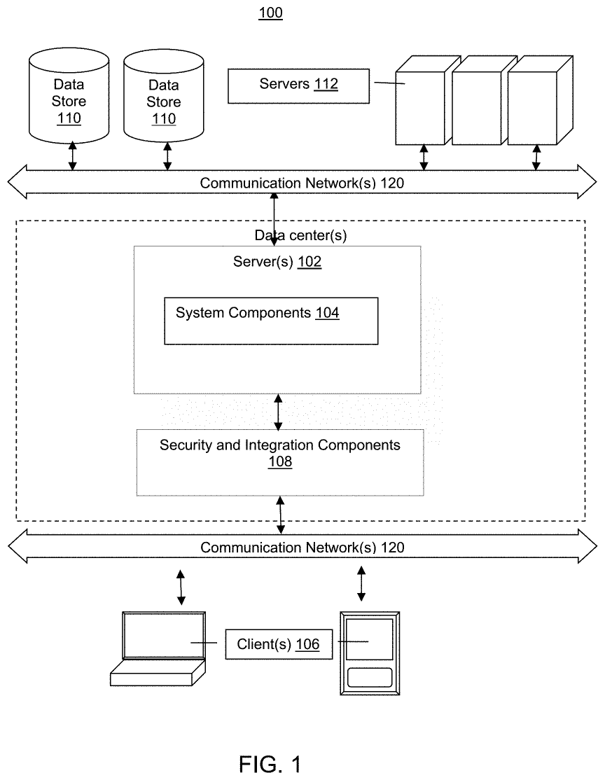

FIG. 1 illustrates a non-limiting example distributed computing environment 100, which includes one or more computer server computing devices 102, one or more client computing devices 106, and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone network (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

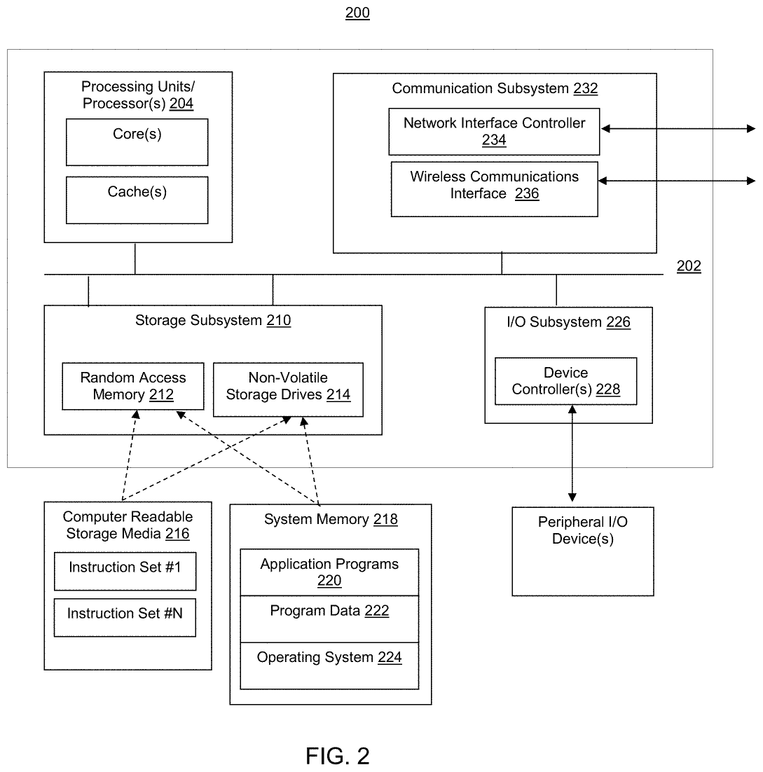

The embodiments shown in FIGS. 1-2 are thus one example of a distributed computing system and are not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser-based applications and/or standalone software applications, such as mobile device applications. Client devices 106 may receive client applications from server 102 or from other application providers (e.g., public or private application stores).

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users,

As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML, encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

Computing environment 100 also may include one or more data stores 110, possibly including and/or residing on one or more back-end servers 112, operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code and may maintain multiple concurrently executing programs or processes. Processor(s) 204 may also include one or more specialized processors, (e.g., digital signal processors (DSPs), outboard, graphics application-specific, and/or other processors).

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include indicator lights, monitors, printers, speakers, headphones, automotive navigation systems, plotters, voice output devices, modems, etc.

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage sub system 210.

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

Formative feedback on student writing is most useful when it is localized to the particular location in the essay that it applies to. Conventional approaches to this localization task require examples of human-provided localized annotations, which is time-consuming and expensive to gather. The disclosed embodiment therefore includes systems and methods to predict annotation spans in student essays without requiring any labeled annotation training data. Specifically, the disclosed embodiments provide for Multiple Instance Learning (MIL) for content feedback localization without annotation, specifically utilizing Automated Essay Scoring (AES) as a MIL task. This approach may predict content scores and localize content by leveraging its sentence-level score predictions, despite never having access to localization training data. This represents a significant improvement over the current and prior states of the art, because MIL has never been and is not currently applied to the AES task, the current and prior state of the art includes no other attempts to approach content localization without access to annotation data. The disclosed system may therefore perform both annotation localization and essay scoring, and may further be utilized for explainable automated essay scoring.

When used as a treatment, the disclosed embodiments could measure how well students improve on their writing as well as whether it allows for students to learn more quickly. It makes it easier to measure student improvement longitudinally. By giving more directed feedback to students, which allows students to be better able to make changes to their writing.

The disclosed embodiments utilize ideas from the machine learning technique of Multiple Instance Learning (MIL) to train an automated essay scoring system that makes predictions at a sentence level, and then utilize those sentence-level score predictions to predict sentences where human annotations would be given. In this explanation, we assume that we are only predicting annotations/scores for one topic, but in practice this can be done for every topic in a rubric.

To train this AES system, the disclosed embodiments may require a corpus of scored student essays. The disclosed embodiments may then split each essay into its constituent sentences and assign to each of these sentences the score of its parent document. The disclosed embodiments may train a regression model (e.g., a k-Nearest Neighbors model) on these sentences, using a distance metric (e.g., the Euclidean distance) to determine the nearest neighbors to a point. This regression model can then be used to predict the score for a new essay by using it to predict scores for each sentence in the essay, and then aggregating the predicted sentence-level scores (e.g., by computing the maximum) to predict the score for the whole essay.

Such an AES system provides sentence-level scores. As these scores indicate how much a sentence appears to be about the specific topic of interest, they can be used as signals for the likelihood of a human annotator would have annotated that sentence as being about the topic. That is, the disclosed embodiments may directly use the sentence-level scores (after rescaling to a [0, 1] range) as probabilities that the topic was discussed in a given sentence.

The experiments disclosed below demonstrate that this system works well for both AES and on the annotation prediction task. The good performance on the annotation prediction task is of particular interest, as the model was never trained on annotation data.

A plurality of use cases may demonstrate the utility of the disclosed embodiments. A first use case may include automated scoring of writing in order to localize different types of errors to aid in formative feedback (including for existing products/services such as Pearson Education's Revel, MyLabs, Writing Solutions, WriteToLearn, and high stakes writing assessment).

A second use case may include explainable automated essay scoring—the scores produced by this system are directly tied to specific sentences in the student response, and so any essay-level score produced by this system can be directly explained in terms of the contributions of the individual sentences in the essay. Such a system could also be used directly on scores provided by a human instructor, to provide that instructor with insight as to which sentences in a piece of student writing appear to have been impactful in their scoring decision.

A third use case may include, given a set of textbooks that have been rated for reading level, using this system to identify sections or chapters that deviate from the overall reading level of the textbook.

A fourth use case may include identifying key dialogue turns in student learning—if the disclosed embodiments had a dialogue-based automatic tutoring system, it could be configured to use this approach to investigate dialogues that showed improved learner outcomes vs those that did not to identify which turns in the dialogue were most important in aiding the learner.

The disclosed embodiments provide an automated scoring system that additionally provides location information, allowing students to leverage a more specific frame of reference to better understand the feedback, encouraging students to better understand and implement revisions because of given feedback that summarizes and localizes relevant information.

The disclosed embodiments automatically provide localized feedback on the content of an essay provided by a user. The specific kinds of feedback provided can vary, ranging from positive feedback reinforcing that a student correctly covered a specific topic, to feedback indicating areas that the student could improve, including errors such as domain misconceptions or inadequate citations, but not omitted topics, which may be outside the scope of localized feedback, as they represent an overall issue in the essay that is best addressed by essay-level feedback.

The disclosed embodiments may take advantage of machine learning perspective, and may further represent a significant improvement in the prior art. In systems in the current state of the art, content localization may be difficult. Current automated localization may be very fine-grained (e.g., grammar checkers can identify spelling or grammar mistakes at the word level). To address this, the disclosed embodiments may analyze the content of a student's essay as primarily a sentence-level aspect of student writing. To provide this type of content feedback, the disclosed systems may detect, within a student's essay, where a student is discussing that particular content. One approach may include collecting a corpus of training data containing essays with annotations indicating text spans where topics of interest were discussed.

A supervised machine learning classifier may then be trained on this data, and in some embodiments, this localization model may then be integrated into a full AES feedback system. For example, a scoring model could identify the degree of coverage of rubric-required topics t1, . . . , tn. A formative feedback system could generate suggestions for inadequately covered topics. Finally, the localization system could identify where this formative feedback should be presented. Some of the disclosed embodiments therefore address the localization part of this process.

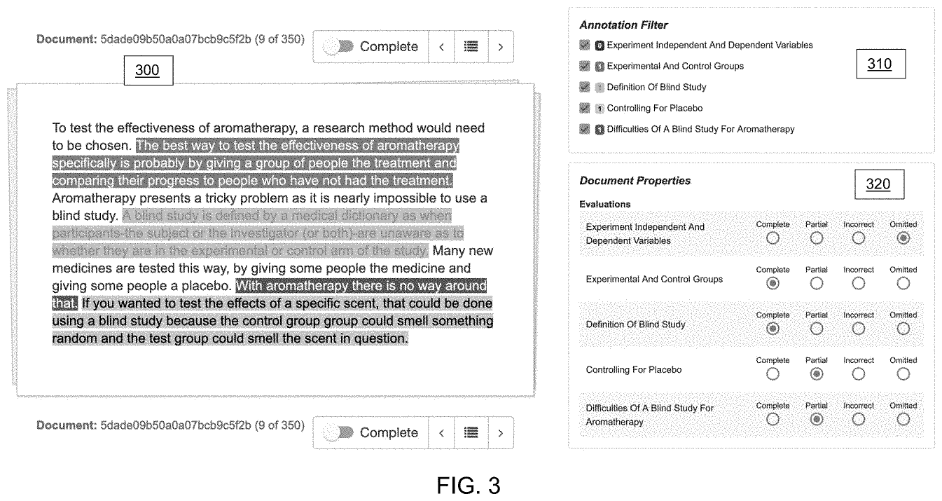

While AES systems typically provide scoring of several rubric traits, the disclosed embodiments are interested primarily in the details of an essay's content, and so the disclosed embodiments focus on a detailed breakdown of content coverage into individual topics. For example, consider a prompt that asks students to discuss how to construct a scientific study on the benefits of aromatherapy, as seen in FIG. 3. Each student answer is a short essay and is scored on its coverage of six content topics. Examples of these topics include discussion of independent and dependent variables, defining a blind study, and discussing the difficulties in designing a blind study for aromatherapy. These kinds of content topics are what the disclosed embodiments' localization efforts are focused on. FIG. 3 shows a screenshot from an annotation tool containing an example essay with human-provided annotations and scores and includes a Screenshot from an annotation tool containing an example essay with colored text indicating human-provided annotations 300, the color-coded annotation key 310 and holistic scores 320.

The downside of building a localization classifier based on annotation data is that such annotation data is very expensive to collect. Holistic scoring data itself is expensive to collect, and obtaining reliable annotations is even more difficult to orchestrate. Due to these issues, the disclosed embodiments represent an approach that eliminates annotation training data, which is desirable. The disclosed embodiments therefore include a weakly-supervised multiple instance learning (MIL) approach to content localization that relies on either document-level scoring information, or on a set of manually curated reference sentences. The disclosed embodiments demonstrate that both approaches can perform well at the topic localization task, without having been trained on localization data.

AES systems for providing holistic scoring, such as the disclosed systems, may be specifically designed to provide formative feedback, with or without an accompanying overall score.

A major drawback of more localized feedback systems in the prior state of the art is the requirement that they be trained on annotation data, which is expensive to gather. The disclosed embodiments remove this constraint and are inspired by approaches that determine the contribution of individual sentences to the overall essay score, possibly by presenting a neural network that generates an attention vector over the sentences in a response. This attention vector directly relates to the importance of each individual sentence in the computation of the final predicted score.

Some embodiments may attempt to localize feedback based purely on the output of a holistic AES model. Specifically, they may train an ordinal logistic regression model on a feature space consisting of character, word, and part-of-speech n-grams. They may then determine the contribution of each sentence to the overall score by measuring how much more likely a lower (or higher) score would be if that sentence was removed. Some embodiments may use the Mahalanobis distance to compute how much that sentence's contribution differs from a known distribution of sentence contributions. Finally, they may present feedback to the student, localized to sentences that were either noticeably beneficial or detrimental to the overall essay.

Some embodiments may differ, in that they aim to predict the locations humans would annotate, rather than evaluating the effectiveness of their localized feedback. Specifically, the disclosed embodiments may frame annotation prediction as a task with a set of essays and a set of labels, such that each sentence in each essay has a binary label indicating whether or not the specified topic was covered in that sentence. These embodiments may therefore develop a model that can predict these binary labels given the essays.

Some embodiments may use Latent Dirichlet Allocation (LDA), an unsupervised method for automatically identifying topics in a document to accomplish the goal of identifying sentences that received human annotations. This requires an assumption that the human annotators identified sentences that could match a specific topic learned by LDA. However, some embodiments may differ from LDA in that they use supervised techniques whose predictions can be transferred to the annotation domain, rather than approaching the problem as a wholly unsupervised task. Additionally, these embodiments may classify sentences by topics rather than explicitly creating word topic models for the topics.

If one views student essays as summaries (e.g., of the section of the textbook that the writing prompt corresponds to), then summarization evaluation approaches could be applicable. In particular, the PEAK algorithm may be used by the disclosed embodiments to build a hypergraph of subject-predicate-object triples, and then identify salient nodes in that graph. These salient nodes are then collected into summary content units (SCUs), which can be used to score summaries. In the disclosed embodiments, these SCUs would correspond to recurring topics in the student essays. One possible application of PEAK to the annotation prediction problem in the disclosed embodiments would be to run PEAK on a collection of high-scoring student essays. Similarity to the identified SCUs could then be used as a weak signal of the presence of a human annotation for a given sentence. The approach in some embodiments of the disclosed embodiments may differ from this application of PEAK in that they not only utilize similarity to sentences from high-scoring essays, but also use sentences from low-scoring essays as negative examples for a given topic.

In some embodiments, to accomplish the goal of predicting annotations without having access to annotation data, these embodiments may approach AES as a multiple instance learning regression problem. Multiple instance learning is a supervised learning paradigm in which the goal is to label bags of items, where the number of items in a bag can vary. The items in a bag are also referred to as instances. MTh is an area of machine learning, associated with natural language processing (NLP) and in general settings. The standard description of MTh assumes that the goal is a binary classification. Intuitively, each bag has a known binary label, and the instances in a bag can be thought of as having unknown binary labels. It can then be assumed that the bag label is some aggregation of the unknown instance labels. MIL may be described in these terms, and then those ideas may be extended to regression.

Formally, let X denote a collection of training data, and let i denote an index over bags, such that each Xᵢ∈xᵢ is of the form Xᵢ={x_{i,1}, x_{i,2}, . . . , x_{i,m}}. Note that m can differ among the elements of X, that is, the cardinalities of two elements Xᵢ, Xⱼ∈X need not be equal. Let Y denote the training labels, such that each X has a corresponding Yᵢ∈{0, 1}. It may be assumed that there is a latent label for each instance x_{i,j}, denoted by y_{i,j}. Note that, in this specific application, x_{i,j}, corresponds to the j-th sentence of the i-th document in the corpus. The standard assumption in MTh asserts that

$${Y}_{i} = \{ \begin{matrix}0 & if ∀ {x}_{i , j} ∈ {X}_{i} , {y}_{i , j} = 0 \\ 1 & if ∃ {x}_{i , j} ∈ {X}_{i} , {y}_{i , j} = 1\end{matrix}$$

That is, the standard assumption holds that a bag is positive if any of its constituent instances are positive. Another way of framing this assumption is that a single instance is responsible for an entire bag being positive.

In contrast, the collective assumption holds that Y is determined by some aggregation function over all of the instances in a bag. Thus, under the collective assumption, a bag's label is dependent upon more than one and possibly all of the instances in that bag.

AES is usually approached as a regression task, so these notions must be extended to regression. The disclosed embodiments adapt the standard assumption, that a single instance determines the bag label, by using a function that selects a single instance value from the bag. These embodiments may use the maximum instance label, and adapt the collective assumption, that all instance labels contribute to the bag label, by using a function that aggregates across all instance labels. These embodiments may use the mean instance label.

MIL may be applied to natural language processing tasks. For example, the disallowed embodiments may train a convolutional neural network to aggregate predictions across sentences in order to predict discussion of events in written articles. By framing this task as a MIL problem, not only can they learn to predict the types of events articles pertain to, they can also predict which sentences specifically discuss those events, possibly by assigning values to sentences and then using aggregation to create document scores have been used for sentiment analysis.

The disclosed embodiments represent an improvement in the art, because applications of MIL in educational domains are not used in the current state of the art.

By framing AES as a MIL problem, the goal of the disclosed embodiments becomes predicting, for each sentence, the score for that sentence, and then aggregating those sentence-level predictions to create a document-level prediction. This goal requires determining both how to predict these sentence-level scores, and how to aggregate them into document-level scores. Note that the disclosed embodiments perform this task independently for each topic t₁, . . . , tₙ, but this discussion is limited to a single topic for clarity.

The AES task may be defined as follows. Assume the disclosed embodiments are given a collection of student essays D and corresponding scores y. The disclosed embodiments may assume these scores are numeric and lie in a range defined by the rubric, possibly using integers, but continuous values could also work. For example, if the rubric for a concept defined the possible scores as Omitted/Incorrect, Partially Correct, and Correct, the corresponding entries in y could be drawn from {0, 1, 2}. The AES task is to predict y given D.

The intuition for why MIL is appropriate for AES is that, for many kinds of topics, the content of a single sentence is sufficient to determine a score. For example, consider a psychology writing prompt that requires students to include the definition of a specific kind of therapy. If an essay includes a sentence that correctly defines that type of therapy, then the essay as a whole will receive a high score for that topic.

The disclosed embodiments approach the sentence-level scoring task using k-Nearest Neighbors (kNN) (Cover and Hart, 1967). Denote the class label of a training example α as y_{α}. For each document in the training corpus, the disclosed embodiments project each sentence into a semantic vector space, generating a corresponding vector that may be denoted as x. The disclosed embodiments assign to x the score of its parent document. The disclosed embodiments then train a kNN model on all of the sentences in the training corpus and use the Euclidean distance as the metric for nearest neighbor computations.

To predict the score of a new document using this model, the disclosed embodiments first split the document into sentences, project those sentences into the vector space, and use the kNN model to predict the score of each sentence. This sentence-level scoring may be defined as a function φ as

$$φ ( x ) = \frac{1}{k} {\sum }_{α ∈ knn ( x )} {y}_{α}$$

where knn(x) denotes the set of k nearest neighbors of x. The disclosed embodiments aggregate these sentence-level scores through a document-level scoring function θ:

$$θ ( {X}_{i} ) = {agg}_{{x}_{i , j} ∈ {X}_{i}} ( φ ( {x}_{i , j} ) )$$

where agg corresponds to either the maximum or the mean—that is, agg determines whether the disclosed embodiments are making the standard or collective assumption.

The disclosed embodiments consider three semantic vector spaces. The disclosed embodiments define the vocabulary V as the set of all words appearing in the training sentences. The first vector space is a tf-idf space, in which each sentence is projected into R^{|V|} and each dimension in that vector corresponds to the term frequency of the corresponding vocabulary term multiplied by the inverse of the number of documents that contained that term.

The disclosed embodiments also consider a pretrained latent semantic analysis space. This space is constructed by using the singular value decomposition of the tf-idf matrix of a pretraining corpus to create a more compact representation of that tf-idf matrix.

Finally, the disclosed embodiments may consider embedding sentences using SBERT, a version of BERT that has been fine-tuned on the SNLI and Multi-Genre NLI tasks. These tasks involve predicting how sentences relate to one another. This means that the SBERT network has been specifically fine-tuned to embed individual sentences into a common space.

While this kNN-MIL model is ultimately trained to predict document-level scores for essays, as a side effect, it also generates a score prediction for each sentence. The central idea is that the disclosed embodiments can directly use these sentence-level scores as weak signals of the presence of annotation spans in the sentences. Concretely, given the trained kNN-MIL model and an essay Xᵢ, the disclosed embodiments predict the presence of annotations as follows. Assume that the minimum and maximum scores allowed by the rubric for the given topic are Sₘᵢₙ and Sₘₐₓ, respectively. The disclosed embodiments leverage the sentence-level scoring function φ to compute an annotation prediction function α:

$$α ( {x}_{i , j} ) = \frac{φ ( {x}_{i , j} ) - {S}_{min}}{{S}_{max} - {S}_{min}}$$

That is, the annotation prediction function α is a rescaling of φ such that it lies in [0, 1], allowing the disclosed embodiments to interpret it as a normalized prediction of a sentence having an annotation.

As the goal is to predict annotation spans without explicit annotation data, the disclosed embodiments also consider a modification of this process. Rather than training the kNN-MIL model on a corpus of scored student essays, the disclosed embodiments could instead use a set of manually curated reference sentences to train the model. The disclosed embodiments may consider two sources of reference sentences.

First, the disclosed embodiments may consider reference sentences pulled from the corresponding rubric, labeled by the topic they belong to. Rubrics often have descriptions of ideal answers and their key points, so generating such a set is low-cost. However, sentences from rubric descriptions may not discuss a topic in the same way that a student would, or they may fail to anticipate specific correct student answers.

For these reasons, the disclosed embodiments also consider selecting reference sentences by manually picking sentences from the training essays. The disclosed embodiments consider all training essays that received the highest score on a topic as candidates and choose one to a few sentences that clearly address the topic. The disclosed embodiments may specifically look for exemplars making different points and written in different ways. These identified sentences are manually labeled as belonging to the given topic, and each one is used as a different reference sentence when training the kNN-MIL model. Typically, just a few exemplars per topic may be sufficient.

Whether the disclosed embodiments collect examples of formal wording from the rubric or informal wording from student answers, or both, the disclosed embodiments must then label the reference sentences for use in the kNN-MIL model. For a given topic, the references drawn from other topics provide negative examples of it. To convert these manual binary topic labels into the integer space that the disclosed embodiments use for the AES task, the disclosed embodiments may assign to each reference sentence the maximum score for the topic(s) it was labeled as belonging to, and the minimum score to it for all other topics.

The key benefit of the approach is that it never requires access to annotation training data. Instead, given a collection of student essays for a new prompt, training a kNN-MIL model for that prompt requires one of a few sources of data. If the disclosed embodiments have human-provided document-level scores for the topics the disclosed embodiments are interested in, the disclosed embodiments can train a kNN-MIL model on those labeled documents. Otherwise, if the rubric contains detailed enough reference sentences and descriptions for the various topics, the disclosed embodiments can train a kNN-MIL model using reference sentences collected from the rubric. And finally, the disclosed embodiments can have a human expert collect examples of the topics of interest from the essays, and then train a kNN-MIL model using those examples as reference sentences.

To evaluate the performance of kNN-MIL, the disclosed embodiments may need student essays that have both document-level scores and annotation spans. Thus, the disclosed embodiments may make use of an existing proprietary corpus developed to explore fine-grained content assessment for formative feedback. This corpus may consist, as a non-limiting example, of student responses to four university-level psychology writing prompts. While the essays may have been originally written and scored against holistic writing traits, a subsequent annotation effort may factor the content trait into multiple topics that represent core ideas or assertions an instructor would expect a student to address within the essay. For example, the topic Comparing Egocentrism from a prompt about Piaget's stages of development may have the following reference answer:
A child in the pre-operational stage is unable to see things from another person's point of view, whereas a child in the concrete operational stage can.

Annotators were tasked with assigning an essay-level rating for each topic with a judgment of Complete, Partial, Incorrect or Omitted. Additionally, they were asked to mark spans in the essay pertaining to the topic—these could be as short as a few words or as long as multiple sentences. Two psychology subject matter experts (SMEs) performed the rating and span selection tasks. Ideally, rating and span annotations would have also been adjudicated by a third SME. However, due to time and cost constraints, the disclosed embodiments lack adjudicated labels for three of the four prompts. For this reason, the disclosed embodiments ran the experiments on both annotators separately.

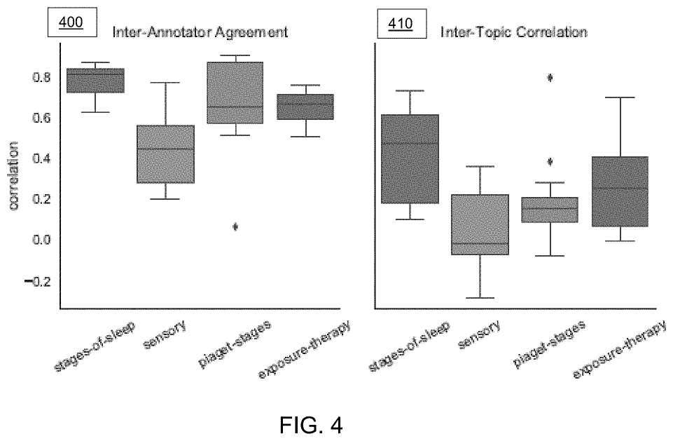

As the techniques work at a sentence-level, but the human annotations can be shorter or longer than a single sentence, the disclosed embodiments frame the annotation prediction task as the task of predicting, for a given sentence, whether an annotation overlapped with that sentence. FIG. 4 is a plurality of box plots of inter-annotator correlations of the sentence-level annotation labels for each topic 400 and correlation between scores for all topic pairs 410. The disclosed embodiments may show the distribution of inter-annotator agreements for the topics in the four prompts in the left panel of FIG. 4, calculated as the correlation between these sentence-level annotation labels. The annotators achieved reasonable reliability except on the Sensory prompt, where the median correlation was below 0.5, and one topic in the Piaget prompt, where the annotators had a correlation near 0.

The features of these four prompts are shown in Table 1. Essays had 5-8 topics and covered areas such as the stages of sleep; the construction of a potential experimental study on aromatherapy; Piaget's stages of cognitive development; and graduated versus flooding approaches to exposure therapy for a hypothetical case of agoraphobia. Table 2 shows how many sentences were available for training the kNN-MIL models for each prompt.

The disclosed approach assumes that the topic scores are numeric. The disclosed embodiments convert the scores in this dataset by mapping both Omitted and Incorrect to 0, Partial to 1, and Complete to 2. As the approach uses these topic scores to generate annotation predictions, its ability to predict different annotations for different topics depends on the topic scores not being highly correlated. The right panel of FIG. 4 shows the distribution of inter-topic correlations for each prompt. While there is considerable variation between the prompts, it is seen that, except for one topic pair on the Piaget prompt, all intertopic correlations are less than 0.8, and the median correlations are all below 0.5.

TABLE 1
Characteristics and summary statistics of prompts
used in the experiments. The Annotator columns
indicate, for a specific topic, the average percentage
of sentences annotated with that topic.

| | # of | # of | Mean | Annotator | Annotator |
|---|---|---|---|---|---|
| Prompt | Essays | Topics | Words | 1 | 2 |
| Sleep Stages | 283 | 7 | 361 | 9% | 8% |
| Sensory Study | 348 | 6 | 395 | 7% | 14% |
| Piaget Stages | 448 | 8 | 367 | 10% | 6% |
| Exposure Therapy | 258 | 5 | 450 | 15% | 9% |

TABLE 2
Number of sentences available for kNN-MIL training. The Rubric
column shows the number of reference sentences taken from the
rubric, while the Student column shows the number manually
chosen from the student essays. The Training column shows the
total number of sentences in the full set of essays.

| Prompt | Rubric | Student | Training |
|---|---|---|---|
| Sleep Stages | 15 | 19 | 4741 |
| Sensory Study | 11 | 13 | 5362 |
| Piaget Stages | 26 | 22 | 6342 |
| Exposure Therapy | 20 | 48 | 5184 |

The goal of the disclosed embodiments is to determine how well the kNN-MIL approaches perform on the annotation prediction task. The disclosed embodiments also want to verify that the approaches perform reasonably well on the essay scoring task—while the disclosed embodiments are not directly interested in essay scoring, if the approaches are incapable of predicting essay scores, that would indicate that the underlying assumptions of the kNN-MIL approaches are likely invalid.

For each prompt, the disclosed embodiments construct 30 randomized train/test splits, holding out 20% of the data as the test set. The disclosed embodiments then train and evaluate the models on those splits, recording two key values: the correlation of the model's document-level scores to the human scorer, and the area under the ROC curve of the model's sentence-level annotation predictions.

The disclosed embodiments compare results between three categories of models. The first is the kNN-MIL model, trained on the training set, and this model may be referred to as the Base kNN-MIL model. The second is the kNN-MIL model trained on a manually curated reference set, which may be referred to as the Manual kNN-MIL model. Finally, the disclosed embodiments compare to the ordinal logistic regression-based approach, which may be referred to as the OLR model. Additionally, as a baseline for comparison on the annotation prediction task, the disclosed embodiments train a sentence-level kNN model directly on the human annotation data, which may be referred to as the Annotation kNN model. The disclosed embodiments consider the Annotation kNN model to provide a rough upper bound on how well the kNN-MIL approaches can perform. Finally, for the kNN-MIL models, the disclosed embodiments investigate how varying k and the vector space impacts model performance.

The disclosed embodiments use the all-threshold ordinal logistic regression model from mord and the part of speech tagger from spaCy in the implementation of the OLR model. The Mahalanobis distance computation for this approach requires a known distribution of score changes, for this the disclosed embodiments use the distribution of score changes of the training set.

The disclosed embodiments use the kNN and tf-idf implementations from scikit-learn and the LSA implementation from gensim. The pretrained LSA space is 300 dimensional and is trained on a collection of 45,108 English documents sampled from grade 3-12 readings and augmented with material from psychology textbooks. After filtering very common and uncommon words, this space includes 37,013 terms, covering 85% of the terms appearing in the training data.

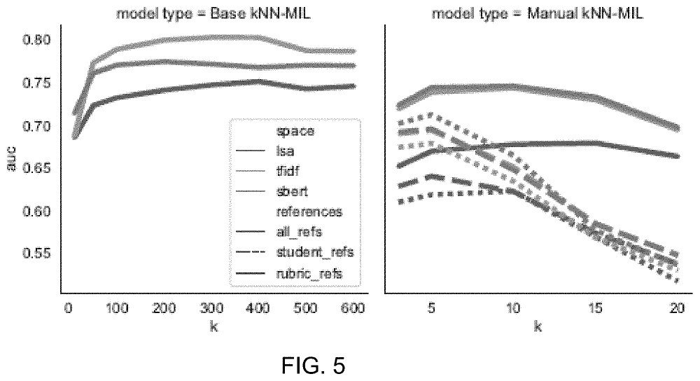

The disclosed embodiments present the average annotation prediction performance of the kNN-MIL models for different values of k in FIG. 5. While all approaches achieve AUCs above 0.5, the LSA-based space performs relatively poorly. The tf-idf space performs well, especially for the Base kNN-MIL model. In the tf-idf space, Base kNN-MIL performance peaks at k=400. For the Manual kNN-MIL models, best performance occurs with the combined reference set using the tf-idf or SBERT spaces, around k=10. Performance for Manual kNN-MIL with only rubric references or student references peaks and declines sooner than for combined due to the set of possible neighbors being smaller.

FIG. 5 represents Annotation prediction performance of the kNN-MIL models as k is varied, averaged across all prompts, concepts, and annotators. Error bars are omitted for clarity. It should be noted that the substantial difference in k between Base kNN-MIL and Manual kNN-MIL is due to the fact that the disclosed embodiments have orders of magnitude fewer manual reference sentences than training set sentences.

In light of these results, for clarity in the rest of this discussion, the disclosed embodiments focus on k=400 for Base kNN-MIL, k=10 and the combined reference set for Manual kNN-MIL and exclude the LSA space. To determine how annotation prediction differs across model types, the disclosed embodiments show the average overall AUC of all models in Table 3. In this table, the disclosed embodiments see that the best performance is achieved when the disclosed embodiments train a kNN model on actual annotation data. In contrast, the OLR model performs relatively poorly, suggesting that its success at predicting sentences that require some sort of feedback does not directly translate into an ability to predict locations of annotations.

TABLE 3
Area under the ROC curve on the annotation prediction task, averaged over
all topics and annotators. Standard deviation shown in parentheses.

| | | Exposure | Piaget | Sensory | Sleep |
|---|---|---|---|---|---|
| Model | Space | Therapy | Stages | Study | Stages |
| Annotation kNN | sbert | 0.88 (0.04) | 0.89 (0.08) | 0.85 (0.06) | 0.91 (0.03) |
| | Tfidf | 0.87 (0.04) | 0.92 (0.07) | 0.89 (0.06) | 0.93 (0.02) |
| Base kNN-MIL | sbert | 0.76 (0.08) | 0.78 (0.09) | 0.77 (0.09) | 0.78 (0.06) |
| | Tfidf | 0.74 (0.06) | 0.84 (0.10) | 0.81 (0.09) | 0.80 (0.07) |
| Manual kNN-MIL | sbert | 0.78 (0.07) | 0.73 (0.12) | 0.70 (0.10) | 0.78 (0.06) |
| | Tfidf | 0.74 (0.08) | 0.77 (0.09) | 0.68 (0.10) | 0.75 (0.07) |
| OLR | | 0.55 (0.04) | 0.63 (0.08) | 0.63 (0.07) | 0.61 (0.05) |

TABLE 4
Pearson correlation coefficients on the document-level scoring task,
averaged over all topics. Standard deviation shown in parentheses.

| Model | agg | Space | Exposure Therapy | Piaget Stages | Sensory Study | Sleep Stages |
|---|---|---|---|---|---|---|
| Base kNN-MIL | max | sbert | 0.49 (0.14) | 0.51 (0.18) | 0.41 (0.15) | 0.60 (0.11) |
| | | tfidf | 0.47 (0.12) | 0.61 (0.19) | 0.52 (0.17) | 0.67 (0.12) |
| | mean | sbert | 0.39 (0.15) | 0.44 (0.16) | 0.36 (0.15) | 0.61 (0.14) |
| | | tfidf | 0.40 (0.14) | 0.52 (0.16) | 0.46 (0.14) | 0.63 (0.13) |
| Manual kNN-MIL | max | sbert | 0.41 (0.15) | 0.30 (0.18) | 0.25 (0.15) | 0.37 (0.14) |
| | | tfidf | 0.38 (0.14) | 0.40 (0.15) | 0.23 (0.16) | 0.34 (0.18) |
| | mean | sbert | 0.29 (0.15) | 0.23 (0.15) | 0.16 (0.15) | 0.27 (0.14) |
| | | tfidf | 0.29 (0.16) | 0.29 (0.13) | 0.19 (0.16) | 0.22 (0.20) |
| OLR | | | 0.50 (0.18) | 0.63 (0.16) | 0.51 (0.18) | 0.69 (0.14) |

Between the different kNN-MIL approaches, Base kNN-MIL using a tf-idf vector space performs best on three of the four prompts, and regardless of vector space, Base kNN-MIL performs as well or better than Manual kNN-MIL on those same three prompts. On the remaining prompt, Exposure Therapy, Manual kNN-MIL with SBERT performs best, but the differences between the various kNN-MIL approaches are relatively small on this prompt.

These annotation predictions results show that the kNN-MIL approach performs well despite never being explicitly trained on the annotation prediction task. While the Base kNN-MIL approach is overall better than the Manual kNN-MIL approach, it also requires a large amount of scored data for training. Which kNN-MIL approach is best for a particular situation thus depends on if the additional performance gain of Base kNN-MIL is worth the added cost of obtaining essay scoring data.

Finally, the disclosed embodiments show performance on the essay scoring task in Table 4. On this task, the OLR model and the Base kNN-MIL model with a tf-idf space perform the best, and the Manual kNN-MIL models perform the worst. The disclosed embodiments had predicted that the standard MIL assumption would perform well for AES, and the results show that this is true—for both Base and Manual kNN-MIL, using the maximum sentence topic score in an answer outperforms using the mean sentence topic score.

The Base kNN-MIL model can perform relatively well at both the document scoring task and the annotation prediction task. This suggests that it could be used as an explainable AES model, as the annotation predictions are directly tied to the document-level scores it provides. In this quite different application, the localization would be used to explain the sentences contributing to the final score, rather than to provide context for formative feedback.

### CONCLUSION AND FUTURE WORK

The disclosed embodiments have presented a novel approach of using MTh to train annotation prediction models without access to annotation training data. This technique performs well and can allow for automated localization without expensive data annotation. It also performs relatively well on the document-level scoring task, suggesting that its sentence-level score predictions could be used as part of an explainable model for AES.

Given that the kNN-MIL approach operates at the sentence level, it is unlikely to correctly locate annotations that exist across multiple sentences. Adapting the method to better incorporate information across sentences (e.g., by incorporating c reference resolution) could help improve its overall performance. Additionally, as the Base kNN-MIL approach uses topics as negative examples for each other, it is not expected that it would not work well in situations where the inter-topic score correlations were high. It is expected that the Manual kNN-MIL approach to be less sensitive to this issue. Determining other ways to include negative examples would allow the Base kNN-MIL approach to be applied to prompts whose topics were highly correlated.

In the current domain, psychology, and in the context of low-stakes formative feedback, incorrect answers are uncommon compared to omitted or partial answers. In contrast, for domains that require chained reasoning over more complex mental models, such as accounting, cell biology, or computer science, it is expected that the ability to correctly detect misconceptions and errors to be far more important. In general, future work is required to determine how well the approach will work in other domains, and which domains it is best suited to.

Determining where topics are discussed is only one step in the full formative feedback process. More work is required to determine the path from holistic scoring and topic localization to the most helpful kinds of feedback for a student. In particular, it is needed to consider different kinds of pedagogical feedback and how such feedback could be individualized. Additionally, the disclosed embodiments could provide not just text but also video, peer interaction, worked examples, and other approaches from the full panoply of potential pedagogical interventions. Finally, it should be decided what actions will help the student the most, which relies on the pedagogical theory of how to help a student achieve their current instructional objectives.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments

What is claimed is:

1. A system comprising:
a data store coupled to a network of computing devices and storing:
a plurality of essays; and
an essay score for each of the plurality of essays;
a server, comprising at least one computing device coupled to the network and comprising at least one processor executing instructions within a memory which, when executed, cause the system to:
parse each of the plurality of essays into a first plurality of essay sentences;
assign each essay sentence in the first plurality of essay sentences a first sentence score comprising the essay score associated with an essay in the plurality of essays from which the essay sentence was parsed;
train a machine learning model using a plurality of essay sentence scores derived from the plurality of essays;
receive, from a client device coupled to the network, an essay response to a prompt;
parse the essay response into a plurality of essay response sentences;
execute the machine learning model according to similarities between the essay response sentences and the first sentence score for each of the first plurality of essay sentences;
calculate, based on the model, an essay response sentence score for each of the essay response sentences, without access to a localization training data.

2. The system of claim 1, wherein the instructions, when executed, further cause the system to generate a graphical user interface (GUI) including a colored text indicating a plurality of human-provided annotations, a color-coded annotation key, and a plurality of holistic scores.

3. The system of claim 1, wherein the instructions, when executed, further cause the system to generate, based on the model, at least one prediction of annotation spans in a plurality of received essays without requiring a labeled annotation training data.

4. The system of claim 1, wherein the instructions, when executed, further cause the system to apply machine learning for content feedback localization without annotation, wherein:
the machine learning is Multiple Instance Learning (MIL), utilizing Automated Essay Scoring (AES) as a MIL task; and
the system is configured to predict content scores and localize content by leveraging a plurality of sentence-level score predictions, despite never having access to the localization training data.

5. The system of claim 1, wherein the instructions, when executed, further cause the system to perform annotation localization and essay scoring, utilized for explainable automated essay scoring.

6. The system of claim 1, wherein the instructions, when executed, further cause the system to:
measure an improvement to writings of a plurality of students; and
determine whether the improvement increases a speed at which the students learn.

7. The system of claim 1, wherein the instructions, when executed, further cause the system to utilize a plurality of sentence-level score predictions to predict at least one sentence where human annotations would be given.

8. A method comprising:
storing, by a server, comprising at least one computing device coupled to a network of computing devices and comprising at least one processor executing instructions within a memory, within a data store coupled to the network:
a plurality of essays; and
an essay score for each of the plurality of essays;
parsing, by the server, each of the plurality of essays into a first plurality of essay sentences;
assigning, by the server, each essay sentence in the first plurality of essay sentences a first sentence score comprising the essay score associated with an essay in the plurality of essays from which the essay sentence was parsed;
training, by the server, a machine learning model using a plurality of essay sentence scores derived from the plurality of essays;
receiving, by the server, from a client device coupled to the network, an essay response to a prompt;
parsing, by the server, the essay response into a plurality of essay response sentences;
executing, by the server, the machine learning model according to similarities between the essay response sentences and the first sentence score for each of the first plurality of essay sentences;
calculating, by the server based on the model, an essay response sentence score for each of the essay response sentences, without access to a localization training data.

9. The method of claim 8, further comprising the step of generating, by the server a graphical user interface (GUI) including a colored text indicating a plurality of human-provided annotations, a color-coded annotation key, and a plurality of holistic scores.

10. The method of claim 8, further comprising the step of generating, by the server, based on the model, at least one prediction of annotation spans in a plurality of received essays without requiring a labeled annotation training data.

11. The method of claim 8, further comprising the step of applying, by the server, machine learning for content feedback localization without annotation, wherein:
the machine learning is Multiple Instance Learning (MIL), utilizing Automated Essay Scoring (AES) as a MIL task; and
the system is configured to predict content scores and localize content by leveraging a plurality of sentence-level score predictions, despite never having access to the localization training data.

12. The method of claim 8, further comprising the step of performing, by the server, annotation localization and essay scoring, utilized for explainable automated essay scoring.

13. The method of claim 8, further comprising the steps of:
measuring, by the server, an improvement to writings of a plurality of students; and
determining, by the server, whether the improvement increases a speed at which the students learn.

14. The method of claim 8, further comprising the step of utilizing a plurality of sentence-level score predictions to predict at least one sentence where human annotations would be given.

15. A system comprising a server, comprising at least one computing device coupled to a network of computing devices and comprising at least one processor executing instructions within a memory, the server being configured to:
store, within a data store coupled to the network:
a plurality of essays; and
an essay score for each of the plurality of essays;
parse each of the plurality of essays into a first plurality of essay sentences;
assign each essay sentence in the first plurality of essay sentences a first sentence score comprising the essay score associated with an essay in the plurality of essays from which the essay sentence was parsed;
train a machine learning model using a plurality of essay sentence scores derived from the plurality of essays;
receive, from a client device coupled to the network, an essay response to a prompt;
parse the essay response into a plurality of essay response sentences;
execute the machine learning model according to similarities between the essay response sentences and the first sentence score for each of the first plurality of essay sentences;
calculate, based on the model, an essay response sentence score for each of the essay response sentences, without access to a localization training data.

16. The system of claim 15, wherein the server is further configured to generate a graphical user interface (GUI) including a colored text indicating a plurality of human-provided annotations, a color-coded annotation key, and a plurality of holistic scores.

17. The system of claim 15, wherein the server is further configured to generate, based on the model, at least one prediction of annotation spans in a plurality of received essays without requiring a labeled annotation training data.

18. The system of claim 15, wherein the server is further configured to apply machine learning for content feedback localization without annotation, wherein:
the machine learning is Multiple Instance Learning (MIL), utilizing Automated Essay Scoring (AES) as a MIL task; and
the system is configured to predict content scores and localize content by leveraging a plurality of sentence-level score predictions, despite never having access to the localization training data.

19. The system of claim 15, wherein the server is further configured to perform annotation localization and essay scoring, utilized for explainable automated essay scoring.

20. The system of claim 15, wherein the server is further configured to utilize a plurality of sentence-level score predictions to predict at least one sentence where human annotations would be given.
